(19) United States
(12) Patent Application Publication
(10) Pub. No.: US 2023/0163994 A1
(43) Pub. Date: May 25, 2023

(54) METHOD AND APPARATUS FOR PROVIDING INFRASTRUCTURE PROCESSING AND COMMUNICATIONS

(71) Applicant: JACK IVAN JMAEV, HACIENDA HEIGHTS, CA (US)

(72) Inventor: JACK IVAN JMAEV, HACIENDA HEIGHTS, CA (US)

(21) Appl. No.: 17/916,552

(22) PCT Filed: Mar. 30, 2021
(86) PCT No.: PCT/US21/25010

§ 371 Date: Jan. 29, 2023

Related U.S. Application Data
(60) Provisional application No. 63/003,715, filed on Apr. 1, 2020.

(51) Int. Cl. H04L 12/28; H04L 12/10; H04L 12/66

(52) U.S. Cl. CPC H04L 12/2854; H04L 12/10; H04L 12/66

(57) ABSTRACT

Method and apparatus for deploying infrastructure electronics. An electronics bay is amounted on a streetlight pole. Power from the streetlight pole is apportioned between a streetlight and a power converter that generates direct current power for the electronics. Electronics are installed onto/into the electronics bay and power delivered to an electronic element is metered.

### RELATED APPLICATIONS

The present application claims priority to Patent Cooperation Treaty (PCT) Application Serial Number PCT/US21/25010 filed on Mar. 30, 2021, which claims priority to U.S. Provisional Application 63/003,715 filed on Apr. 1, 2020 wherein both of these applications are entitled “METHOD AND APPARATUS FOR PROVIDING INFRASTRUCTURE PROCESSING AND COMMUNICATIONS”, by Jmaev, the text and figures of those application are incorporated by reference into this application in their entireties.

### BACKGROUND

In the wake of the global pandemic, we all realize that our infrastructure was just barely able to keep up with the demand for Internet access. Communications, entertainment, and public safety all require high-bandwidth data communications. Unfortunately, most of our infrastructure has been built up using ground-based, wired communications pathways. Thankfully, fiber optic cables provide high-bandwidth communications. However, fiber optic cables are not available throughout the country.

Many have contemplated the use of wireless data communications systems. However, as wireless data communications systems are called upon to deliver greater and greater data bandwidth, the power required to achieve long-range connections becomes prohibitive. In order to overcome some of these shortfalls, many have looked to more distributed systems. In these distributed systems, high numbers of data-nodes required. These data-nodes, in some illustrative use cases, would be used in a mesh-network system.

It has long been realize that streetlights are so ubiquitous that they could easily serve support data-nodes some 30 feet in the air. Because streetlights are so ubiquitous, a data-node mounted on the streetlight would allow a plethora of applications to be fielded. In fact, many have created proprietary electronics platforms to support data communications and surveillance. General Electric produces a product called CityIQ, which he claims to be a ubiquitous digital infrastructure node. This product integrates various electronics and sensors. However, the CityIQ product is quite proprietary and cannot easily be altered after deployment. Another problem with such proprietary solutions is that, once it is installed by the city streetlight, it precludes the introduction of additional services by additional vendors. So, once a vender like General Electric captures a portion of this market, other vendors are effectively blocked from the captured streetlights.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

In many cases, description of various alternative example methods is augmented with illustrative use cases. Description of how a method is applied in a particular illustrative use case is intended to clarify how a particular method relates to physical implementations thereof. Such illustrative use cases are not intended to limit the scope of the claims appended hereto.

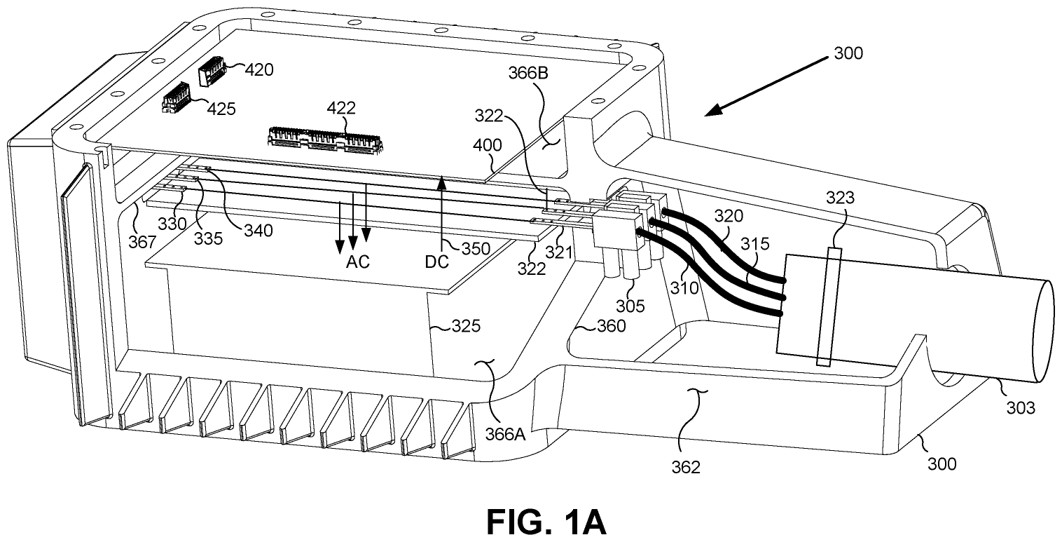

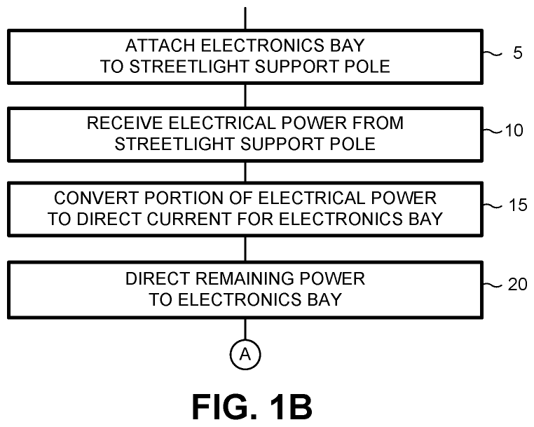

FIG. 1A is a pictorial diagram that illustrates one example embodiment of an electronics platform intended to be used in conjunction with a streetlight. In this example embodiment, the platform 300 comprises a mounting mechanism 323 for attaching the platform 300 to a streetlight support pole 303. According to one alternative example embodiment, the mounting mechanism 323 comprises a simple clamp. This example embodiment of a platform 300 further includes an electrical connector 305, which is configured to accept power from power lines emanating from the streetlight support pole 303.

As pictured in the diagram, one particular use case provides for receiving an earth ground cable 315, a first power phase cable 320 and at least one or more of a second power phase cable 310 and/or a neutral cable 310. It should be appreciated that according to various illustrative use cases, a streetlight support pole 303 will provide a single phase of power, relative to a neutral return. In this case, the neutral is referred to as a “second power phase”. In other illustrative use cases, the streetlight support pole 303 provides two phases of power, which are typically 180° out of phase with each other, and also provides an earth ground cable.

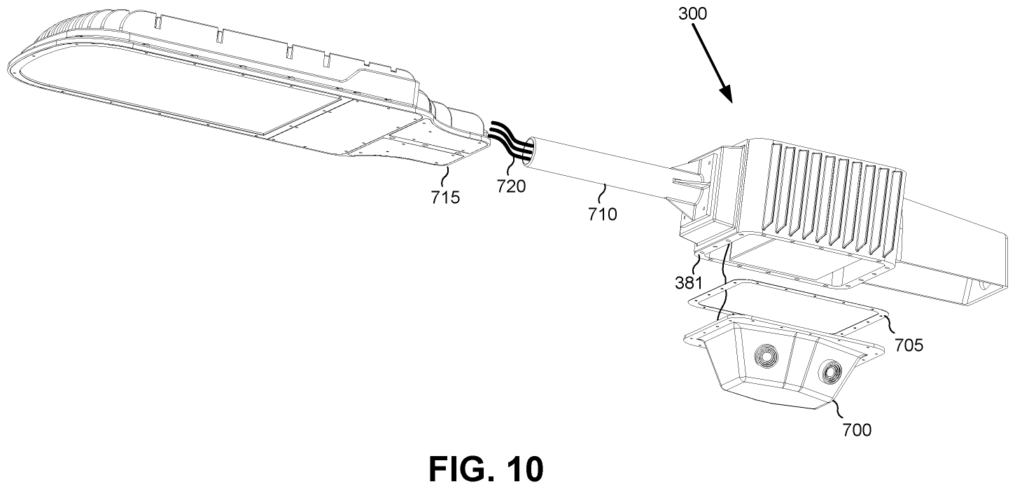

FIG. 1B is a flow diagram that depicts a corresponding method for providing infrastructure processing and communications. The example apparatus herein described embodies such an illustrative method. As such this example method includes a step for deploying an electronics bay by attaching the electronics bay to a streetlight support pole (step 5). In an additional included step, electrical power is received from the streetlight support pole (step 15). In yet another included step, a portion of the electrical power is converted into direct-current power (step 20) to be used by electronics, which are intended to be deployed in the electronics bay. An additional and/or a remaining portion of the electrical power is directed to a streetlight support member, which is also attached to the electronics bay. This is well illustrated in FIG. 10, infra.

FIG. 1A also depicts that the power connector 305 protrudes through a rear bulkhead 360. In this example embodiment, the rear bulkhead 360 separates a rear portion 362 of the platform 300 from an inner portion of the platform 366. In this alternative example embodiment, a rear portion 362 of the platform 300 is only lightly sealed against the environment. The volume that constitutes the rear portion 362 receives a streetlight support pole 303, which is gasketed by a rubber gasket. In some alternative example embodiments the rubber gasket comprises a neoprene gasket. It should be appreciated that it is difficult to provide a substantially hermetic seal between the rear portion 362 of the platform 300 and the outside environment.

FIG. 1A also depicts that the platform 300 includes an inner portion 366. The inner portion 366 comprises an electronics bay which is substantially sealed from the outside environment. For example, the electrical connector 305 transitions to metal bus bars 321 which are hermetically sealed by a sealant introduced within an orifice through which the metal bus bars penetrate a rear bulkhead 360.

FIG. 1A also illustrates that electrical power is directed to a power transition module 322 from the input power lines by way of the bus bars 321. The power transition module 322, which in some embodiments comprises a printed circuit board, provides an electrical connection to a set of output bus bars 330, 335 and 340. These bus bars carry out the power to the streetlight through another hermetic assembly akin to the input power connector 305.

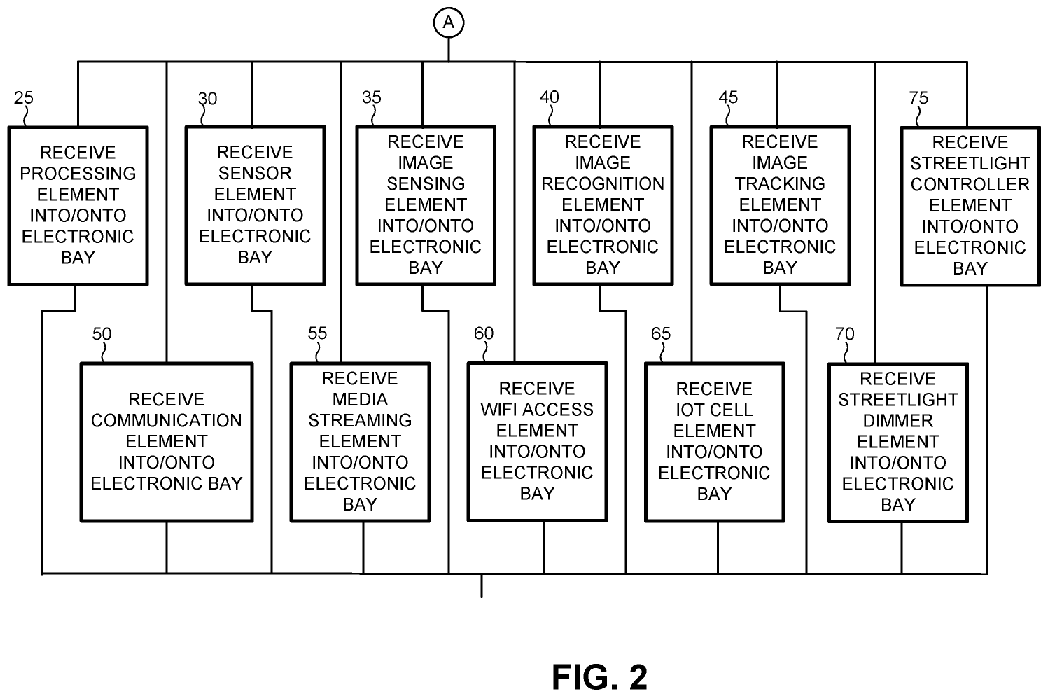

FIG. 2 is a flow diagram that depicts one alternative example method for providing communication and processing capabilities for infrastructure. According to this alternative example method, one or more electronic elements are received either into or onto the electronic bay heretofore described. It should be appreciated that, according to various illustrative example methods, the electronics bay includes an inner portion, which, according to various illustrative embodiments of the present method, is substantially hermetically sealed from an external environment.

According to this alternative example method, a wide variety of sundry electronic elements are received into the electronics bay. In one alternative example method, a processing element is received into/onto the electronics bay (step 25). In yet another alternative example method, a sensor element is received into/onto the electronics bay (step 30). And in yet another alternative example method, an image sensing element is received into/onto the electronic bay (step 35). According to yet another alternative example method, an image recognition element is received into/onto the electronics bay (step 40). According to yet another alternative example method, an image tracking element is received into/onto the electronics bay (step 45).

In order to support establishment of wireless infrastructure using the electronics bay heretofore described, one alternative example method provides for receiving a communications element into/onto the electronics bay (step 50). It should be appreciated that, according to various alternative example methods, the communications element comprises at least one or more of a Wi-Fi modem (step 60), an Internet of things cell controller (step 65), a 4G modem, a 5G modem, and/or a ring network element. These are but examples of the types of communications elements that are contemplated by the claims appended hereto. Accordingly, this enumeration is not intended to limit the scope of the appended claims.

According to some illustrative use cases, the electronics bay heretofore described is used to support the delivery of streaming media. Accordingly, one alternative example method provides for receiving a media streaming element into/onto the electronics bay (step 55). According to various illustrative use cases, the media streaming element comprises at least one or more of a micro-media server and/or a solid-state disk drive element.

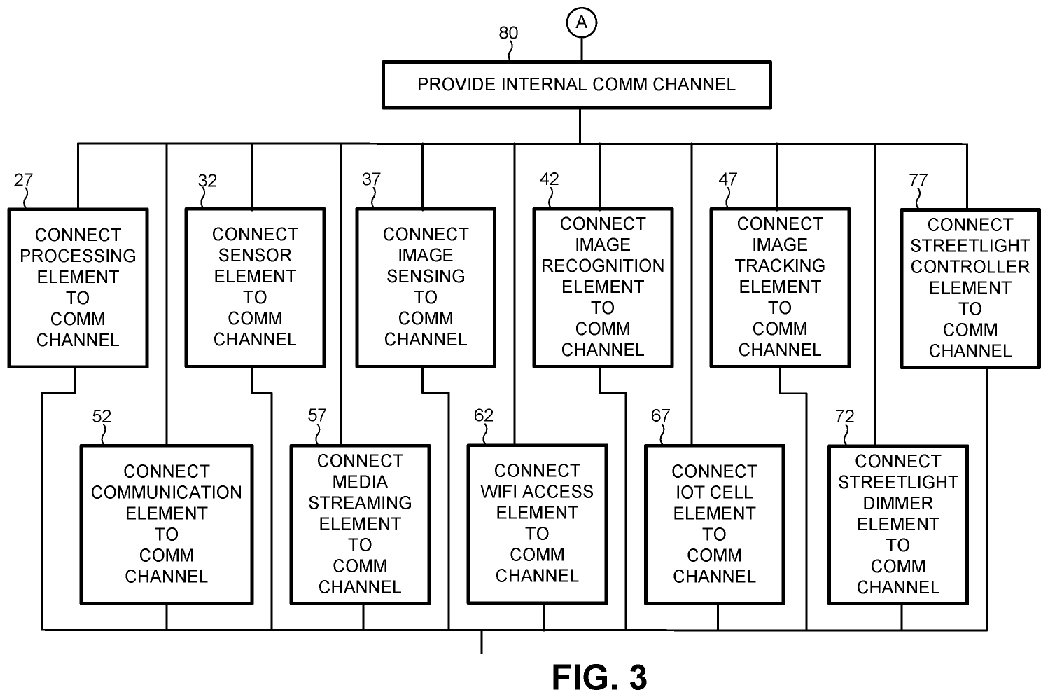

FIG. 3 is a flow diagram that depicts one alternative example method for providing communications amongst one or more electronic elements received into/onto the electronics bay. It should be appreciated that, according to various alternative example methods, receiving an electronic element also provides a step for interfacing the electronic element to a particular computer bus structure. Such a computer bus structure serves as an internal communications channel (step 80), which is provided according to an included step in this alternative example method. According to one alternative example method, interfacing the electronic element to a particular computer bus structure comprises a step for interfacing the electronic element to at least one or more of a parallel computer bus, the serial computer bus, a channelized computer bus, an STD Bus structure, an STD32 Bus structure, a VME Bus structure, a VME 64 Bus structure, a PCI bus structure, a PCIe bus structure, a PCI/104 bus structure, and/or a PCIe/104 bus structure.

Irrespective of the type of internal communication channel provided, one alternative example method provides for connecting a received processing element to the internal communication channel (step 27). With respect to this figure, the notion of connecting an electronic element to the internal communication channel is understood to be a communicative coupling of a particular electronic element received into/onto the electronics bay to the internal communication channel, as depicted in step 80.

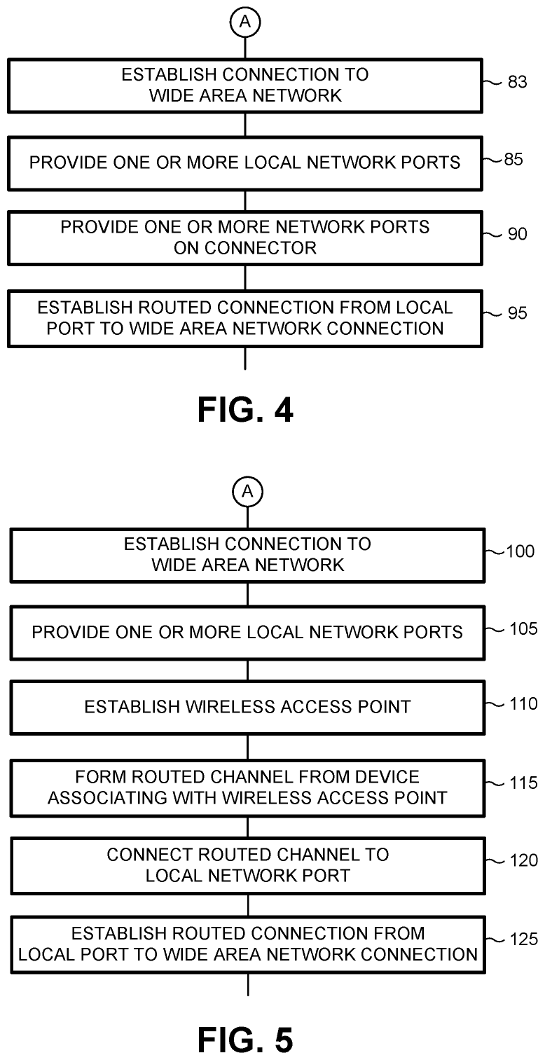

FIG. 4 is a flow diagram of a method for providing wide area network access to one or more electronic elements installed into/onto the electronics bay. According to this example alternative method, but included step provides for establishing a connection to a wide area network (step 83). This alternative example method further comprises a step for providing one or more local network ports (step 85) and providing these local network ports on a connector (step 90). In one alternative example method, the connector comprises a stackable connector. It should be appreciated that a stackable connector allows for electronic modules to be stacked one on top of another and allows each electronic module to communicatively coupled to at least one local area network port. It should also be appreciated that, in those embodiments where electronic elements are coupled together by way of a linear bus, non-stackable connectors are utilized. In such case, each non-stackable connector provides one or more local network ports.

According to this alternative example method, once a connection to a wide area network is established (step 83), a routed connection is established from a local port to the wide area network connection (step 95). It should be appreciated that, according to various illustrative use cases, this is established by a network router included in an integrated system supported by the electronics platform 300.

FIG. 5 is a flow diagram of an alternative method for providing a wireless network access point. In this alternative example method, and included step provides for establishing a connection to a wide area network (step 100). This alternative example method further includes a step four providing one or more local network ports (step 105), establishing a wireless access point (step 110), forming a routed channel from a device associating with the wireless access point (step 115), connecting the routed channel to at least one of the local network ports (step 120), and establishing a routed connection from the local port to the wide area network connection (step 125).

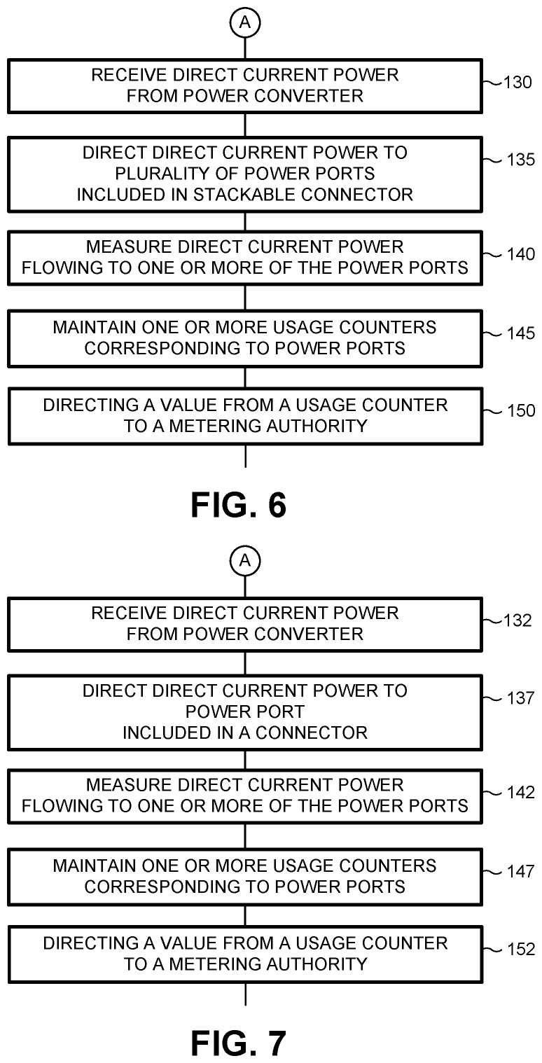

FIG. 6 is a flow diagram that depicts one alternative example method wherein the amount of power utilized by a stackable electronic element is measured. According to this alternative example method, direct-current powers received from a power converter (step 130). The direct-current power is directed one or more power ports, which are included in a stackable connector (step 135). It should be again appreciated that a stackable connector facilitates the use of stackable electronic elements, such as PCI 104e/104 and other types of stackable electronic modules.

As the direct-current power is provided to a power ports included in a stackable connector, the amount of current is measured (step 140). It should be likewise appreciated that, according to one alternative example method, the amount of current provided to each individual power port is measured. This example method includes a step for maintaining one or more usage counters, each of which corresponds to one of the power ports provided (step 145). In order to allow a power provider to recoup energy costs, this example method includes a step for directing a value from a usage counter to a metering authority (step 150). In this manner, different applications housed in the electronics platform are held accountable for the power each such application uses over the course of a billing period.

FIG. 7 is a flow diagram that depicts one alternative example method wherein the amount of power utilized by a non-stackable electronic element is measured. According to this example alternative method, the step is provided for receiving direct-current power from a power converter (step 132). This alternative example method provides an additional step for directing direct-current power to a power port included in a connector (step 137). It should likewise be appreciated that non-stackable electronic elements each require their own individual connector for interfacing to an internal communication channel. As such, power to such a non-stackable electronic element is also included in an individual connector that interfaces to such an electronic element. It should be appreciated that, according to various illustrative use cases, the power port is included in at least one or more of a communications channel connector and/or an independent power port connector.

Analogous to the method where a stackable electronic element receives power from a stackable connector, the amount of direct-current power flowing to a non-stackable electronic element is measured, is provided in an additional included method step (step 142). This alternative example method also includes a step for maintaining one or more usage counters, wherein such usage counters corresponds to power ports included in one or more individual connectors for providing power to one or more non-stackable electronic elements (step 147). In order to allow a power provider to recoup energy costs, this example method includes a step for directing a value from a usage counter to a metering authority (step 152). In this manner, different applications housed in the electronics platform are held accountable for the power each such application uses over the course of a billing period

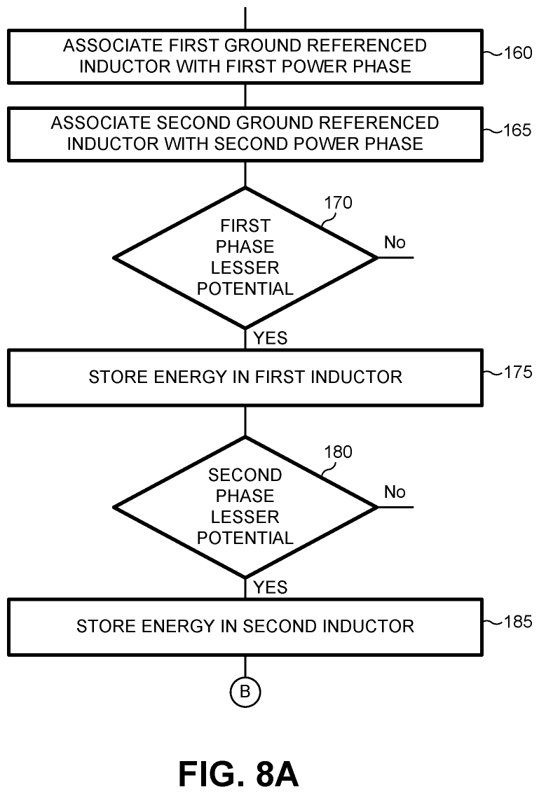

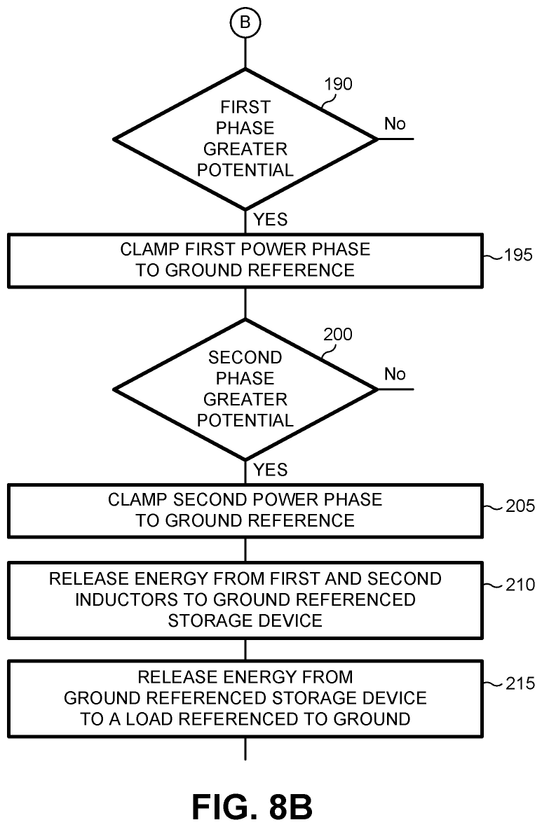

FIGS. 8A and 8B collectively form a a flow diagram that depicts one alternative example method for converting a portion of the electrical power into direct-current power for electronics housed in the electronics platform. One problem exhibited by prior art solutions is the fact that streetlight mounted electronics must be capable of operating over long periods of time. In fact, traditional high-pressure sodium lamp fixtures can easily operate for 30 years without much maintenance at all. Electronic elements that are installed on a light pole need direct-current to operate.

Another requisite imposed by power utility companies is that direct-current power supplies ought to operate in a power factor correction mode. In order to achieve power factor correction, traditional power supplies create a direct-current (“DC”) link bus. The DC link bus must be operated at a voltage substantially higher than the peak voltage of an alternating current (“AC”) power source. Because the DC link bus needs some form of filtering, capacitors are typically used as energy storage devices on the DC link bus. Further reducing reliability of such systems is the fact that high-voltage DC link buses are typically filtered by electrolytic capacitors. It is well understood that electrolytic capacitors have limited lifetimes, which follow far short of the required lifespan of electronics installed on a light pole.

This alternative example method comprises a step for associating a first ground referenced inductor with a first power phase (step 160) and also includes a step for associating a second ground referenced inductor with a second power phase (step 165). It should be appreciated that, in all of the discussions herein related to a first and/or second power phase, either the first and/or the second power phase comprises an active power phase. According to a variation of the present example method, either the first or the second power phase comprises a neutral return path for a complementary power phase. To be clear, the present method and various embodiments thereof are intended to be operated with at least one or more of two active phases, and/or one active phase and a return path for the active phase. It is not relevant as to which of the phases constitutes an active phase in which constitutes a neutral return path for a phase.

This method further includes steps for storing energy in the first inductor (step 175) when the voltage potential of the first phase is less than the voltage potential of the second phase relative to a ground point (step 170). This alternative example method also includes steps for storing energy in the second inductor (step 185) when the voltage potential of the second phase is lesser than the voltage potential of the first phase (step 180).

As energy is stored in the two ground referenced inductors, it is released into a ground referenced storage device (step 210).

It should be appreciated that, in order to complete a current path to a power source, the first power phase is clamped to the ground referenced (step 195) when the potential of the first power phase is greater than the potential of the second power phase. Correspondingly, the second power phase is clamped to the ground reference (step 205) when the voltage potential of the second phase is greater than the voltage potential of the first phase.

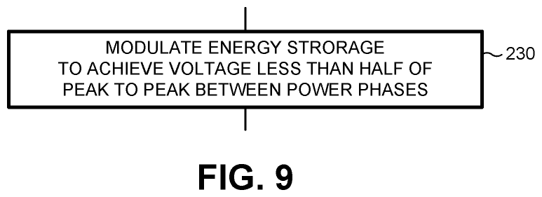

FIG. 9 is a flow diagram that depicts one example alternative methods for storing energy in the first and second inductors. According to this alternative example method, storing energy in either the first and/or second inductors comprising modulating the duty cycle of energy storage in order to establish a voltage relative to the ground reference that is less than half of the peak to peak value between the two power phases. Unlike prior art solutions, which required a DC link voltage that was substantially higher than the positive peak voltage of either phase, the present alternative example method supports a low voltage DC link bus where the voltage of the DC link bus is lower than the positive peak voltage of either phase. This step 230 is included in this alternative example method.

FIG. 1A, which depicts several alternative example embodiments of an electronics platform, depicts that according to one example embodiment the electronics platform comprises a streetlight hole mounting mechanism 323. As already described, this, according to some alternative embodiments, comprises a simple clamp. Also included in this example embodiment is an electronics bay 366. In one alternative example embodiment, the electronics bay 366A is segregated into a lower portion and an upper portion 366B. Such segregation is accomplished by a horizontal bulkhead 367 which is also included in this alternative example embodiment.

FIG. 10 is a pictorial diagram that illustrates one illustrative use case for the platform. In this illustrative use case, the platform 300 is augmented with a mounting pipe 710 which is included in yet another alternative example embodiment. The mounting pipe 710 is used to receive a streetlight fixture 715. Power and control wires 720 emanating from the mounting pipe 710 are connected to electrical elements included in the streetlight fixture 715. According to yet another alternative example use case, an optical sensor assembly 700 included in one alternative example embodiment is mounted on the bottom of the platform 300. In this alternative example use case, a gasket 705 is disposed between the optical sensor assembly 700 and bottom mounting surface included in the platform.

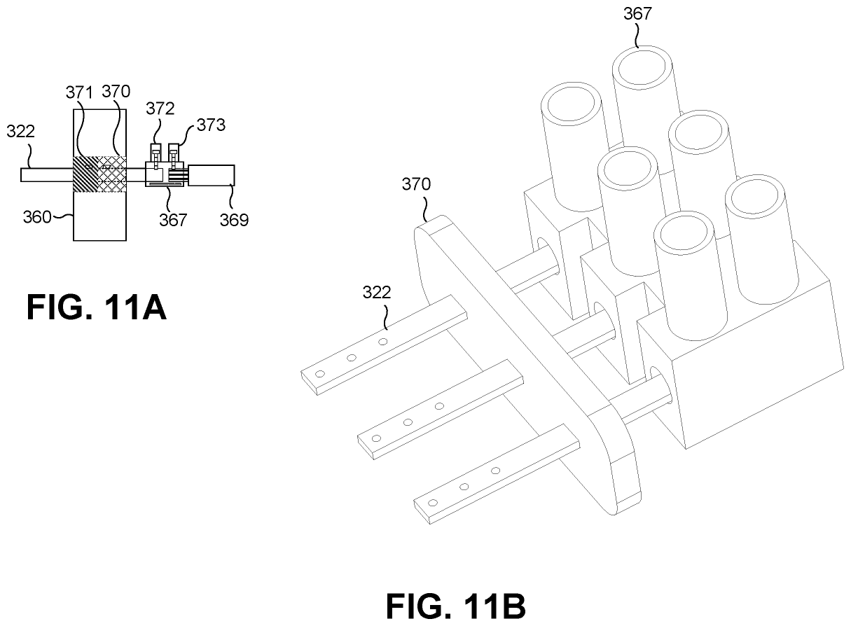

FIG. 11A is a pictorial illustration depicting a power feed-through. FIG. 11A depicts a cross-section of a power feed-through, which is included in one alternative example embodiment of the platform 300, and also a perspective view of the feed-through apparatus structure. It should be appreciated that, in order to maintain a substantially hermetic seal within the electronics bay, is necessary to compartmentalize various portions of platform 300. For example, the lower inner portion 366A, which comprises the electronics bay, is separated from the rear portion 362 of the platform 300 by means of a rear bulkhead 360. In order to bring electrical power into the inner portion 366, i.e. the electronics bay, from the rear portion of the platform 300, a barrier strip connector 367 is used to receive electrical wires 369. This is also depicted in FIG. 1 where electrical wires are brought to the power connector 305. According to one alternative example embodiment, the barrier strip connector 367 comprises a European barrier strip, e.g. Altech Corporation part number HE16HWPR/03. This particular European barrier strip by Altech Corporation is well-suited for this application in that it provides a very wide center to center spacing of 15 mm, thereby providing sufficient dielectric withstand voltage from one terminal to the next.

FIG. 11B is a perspective view of the connector assembly and depicts that the power connector 305, according to one alternative example embodiment of the platform 300, comprises such barrier strip connector 367, a plurality of metal bus bars 322, a centering plate 370, and a sealant 371 (shown in FIG. 2A), which is applied about the metal bus bars 322 in order to establish a hermetic seal between the metal bus bars 322 and the rear bulkhead 360. As shown in the perspective view, the centering plate 370 is used to hold the plurality of metal bus bars in a pre-established pattern so as to maintain dielectric strength from bus-bar to bus-bar and from bus-bar to the rear bulkhead 360.

It should be appreciated that the barrier strip 367, according to this example embodiment, comprises a flow-through barrier strip. This means that there are two contacts per electrical path. In this particular application, the metal bus bars 322 are inserted into a forward facing contact 372 and an electrical conductor 369 is inserted into a rear facing contact 373. The forward facing contact 372 and the rear facing contact 373 are electrically connected to each other.

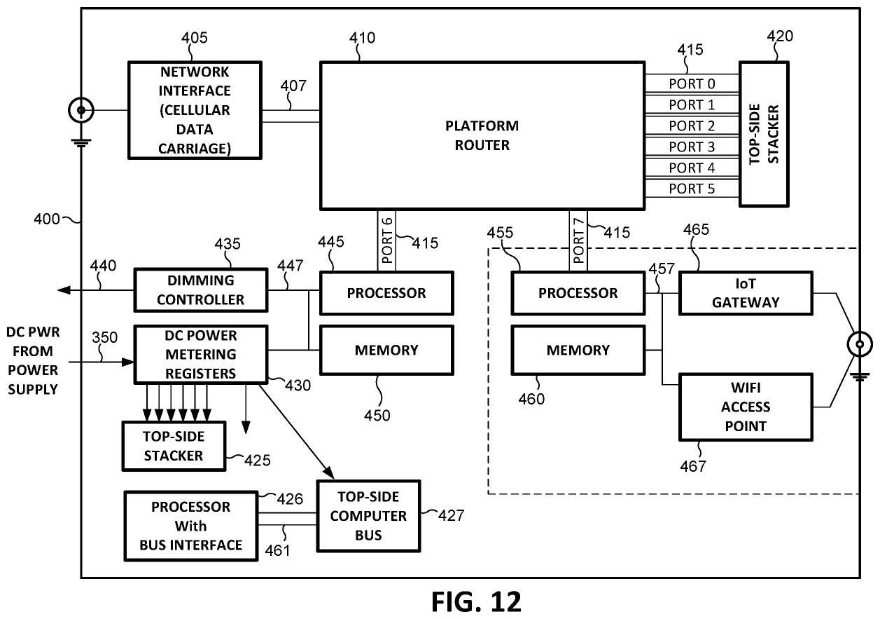

FIG. 12 is a block diagram that depicts one example embodiment of a platform controller included in one alternative example embodiment of a platform. This example embodiment of a platform controller 400 comprises a DC power metering circuit 430. The DC power metering circuit 430 receives DC power 350 from the power supply 325. The DC metering circuit provides a plurality of DC power ports, each of which is individually metered, to a top-side stacking connector 425. The DC power metering circuit 430 also provides power to a topside computer bus connector 427. The individual DC power ports have associated therewith individual power meter registers that are included in the DC power metering circuit 430 and which are available to a platform processor 445. This example embodiment of the platform controller 400 includes such platform processor 445, a platform memory 450. The processor 445 is communicatively coupled to the platform memory 450 by way of a platform bus 447.

The processor 445 executes an instruction sequences stored in the memory 450, which causes the processor 455 to retrieve a value from a DC power metering register 430 and convey it to a local area network port provided by the platform router 410. In this alternative example embodiment, instruction sequences stored in the memory 450 causes the processor 455 to respond to a query received from a wide area network by way of the cellular data carriage 405 and routed to the processor 445 by the platform router 410.

Yet another alternative example embodiment, the platform controller 400 further includes a dimming controller 435. In this alternative example embodiment, the dimming controller 435 is communicatively coupled to the platform processor 445. The platform processor 445, in this example embodiment, communicates dimming commands to the dimming controller 435. The dimming controller 435, in turn, generates dimming signals 440 that are directed to a streetlight.

In yet another alternative example embodiment, the platform controller 400 further includes a platform router 410 and a network interface 405. In yet another alternative example embodiment, the network interface comprises a cellular data carriage. It should be appreciated that a cellular data carriage allows data connectivity to a wireless cellular system. It should also further be appreciated that the network interface 405, according to various alternative example embodiments, comprises at least one or more of a wired network interface, a fiber network interface, and/or a wireless network interface.

In this alternative example embodiment, the network interface 405 is communicatively coupled 407 to the platform router 410. The platform router 410 establishes and manages a plurality of network interfaces 415. Accordingly, such network interfaces for 15 or included in this alternative example embodiment of the platform controller 400. In this alternative example embodiment, the one or more network interfaces 415 are directed to a top-side stacker connector 420.

In yet another alternative example embodiment, one of the network interfaces 415 is communicatively coupled to the platform processor 445. It should be appreciated that the platform router 410 performs all necessary functions to enable discrete network interfaces 415 to communicate by way of a single network address. For example, in one illustrative use case, a single Internet protocol address is used by the network interface 405 to communicate with the Internet. The platform router 410 then channels individual data packets to a particular network interface according to well-established protocols. The platform router 410 provides network routing capability.

According to yet another alternative example embodiment, the platform controller 400 further includes a gateway processor 455. In this alternative example embodiment, the gateway processor 455 is communicatively coupled to the platform router 410 by way of one of the network interfaces 415. The gateway processor 455 is also communicatively coupled to a gateway memory 460, which is included in this alternative example embodiment of a platform controller 400. The gateway processor 455 is communicatively coupled to the gateway memory 460 by way of a gateway bus 457.

In one alternative example embodiment, the platform controller further comprises at least one or more of an IoT gateway 465 and/or a Wi-Fi access point 467. it should be appreciated that the one or more of the IOT gateway for 65 and/or the Wi-Fi access point 467 or communicatively coupled to the gateway processor 455 by way of the gateway bus 457. According yet another alternative example embodiment, the IOT gateway 465 comprises a network control cell for at least one or more of a LoRa network, a Buzbee Network and/or a sigFox network. It should likewise be appreciated that the Wi-Fi access point comprises a network access point for the IEEE 802.11 standard and all of its variations. It should be appreciated that where a particular network protocol is herein specified, the claims appended hereto are to read upon an entire family of network protocols as defined by the most recent specification of such network protocol and all proceeding versions of said specification that have been supplanted or augmented by the most recent version.

According to one illustrative use case, the gateway processor 455 establishes a communication with a gateway server in order to provide communication from the gateway server to the IOT gateway 465. According yet another illustrative use case, the gateway processor 455 establishes a gateway with a Wi-Fi neighborhood network server and the Wi-Fi access point 467. In either of these cases, the gateway processor 455 establishes of communication by way of the network interface 405 using one of the network interfaces 415 established by the platform router 410.

It should be appreciated that, according to various illustrative use cases, the platform processor 445 executes functional processes that are stored in its associated memory 450. By executing such functional processes, which comprise instruction sequences stored in the memory 450, the platform processor 445 embodies custom capabilities, which may be specified by different users of the platform 300. In an analogous manner, the gateway processor 455 executes functional processes that are stored in its associated memory 460 in order to custom capabilities that are also specified by different users of the platform 300. In this manner, the platform controller 400 provides a flexible structure enabling different customers and users of the platform 300 to specify particular functions and capability and to embody those functions and capability enter firmware that is stored in either the platform processors memory 450 or the gateway processor's memory 460.

The functional processes (and their corresponding instruction sequences) described herein enable a processor to embody custom capabilities in accordance with the techniques, processes and other teachings of the present method. According to one alternative embodiment, these functional processes are imparted onto computer readable medium. Examples of such medium include, but are not limited to, random access memory, read-only memory (ROM), Compact Disk (CD ROM), Digital Versatile Disks (DVD), floppy disks, flash memory, and magnetic tape. This computer readable medium, which alone or in combination can constitute a stand-alone product, can be used to convert a general or special purpose computing platform into an apparatus capable of performing custom capabilities according to the techniques, processes, methods and teachings presented herein. Accordingly, the claims appended hereto are to include such computer readable medium imparted with such instruction sequences that enable execution of the present method and all of the teachings herein described.

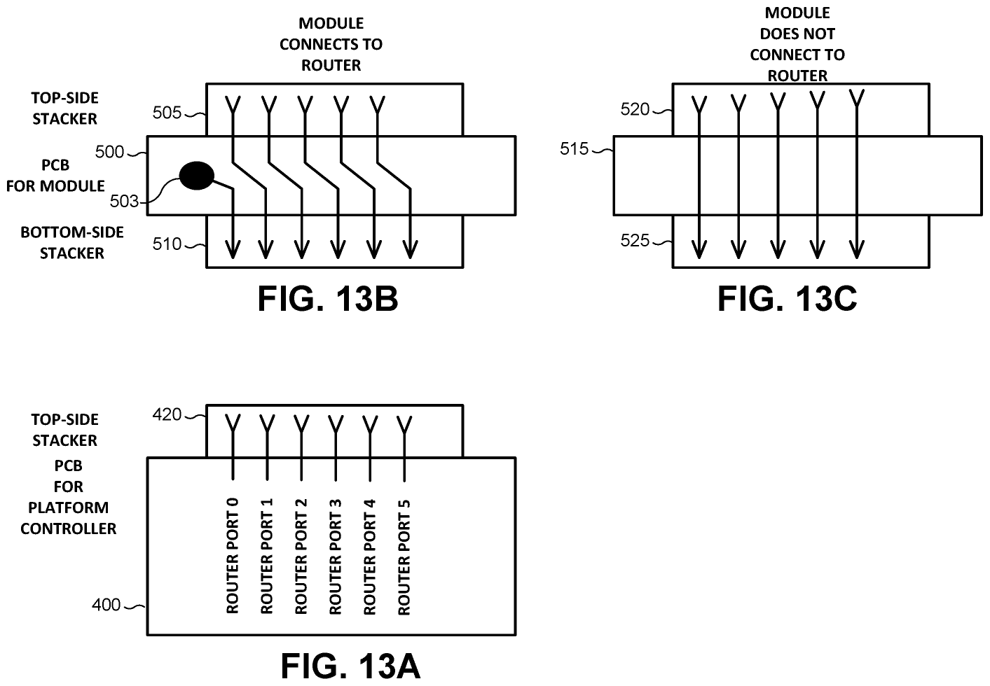

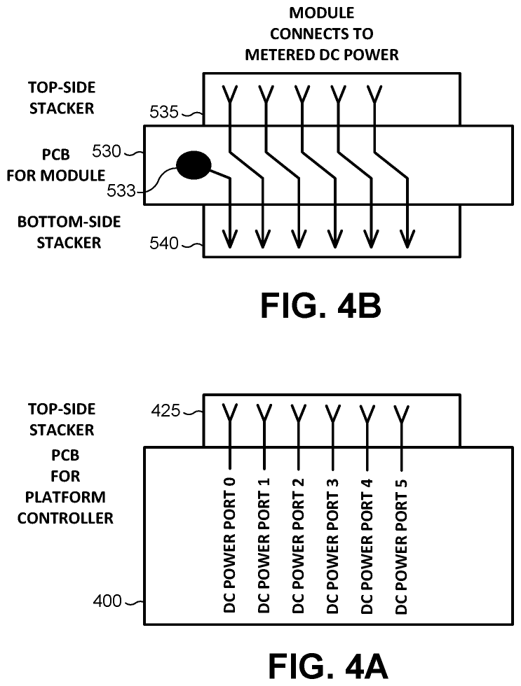

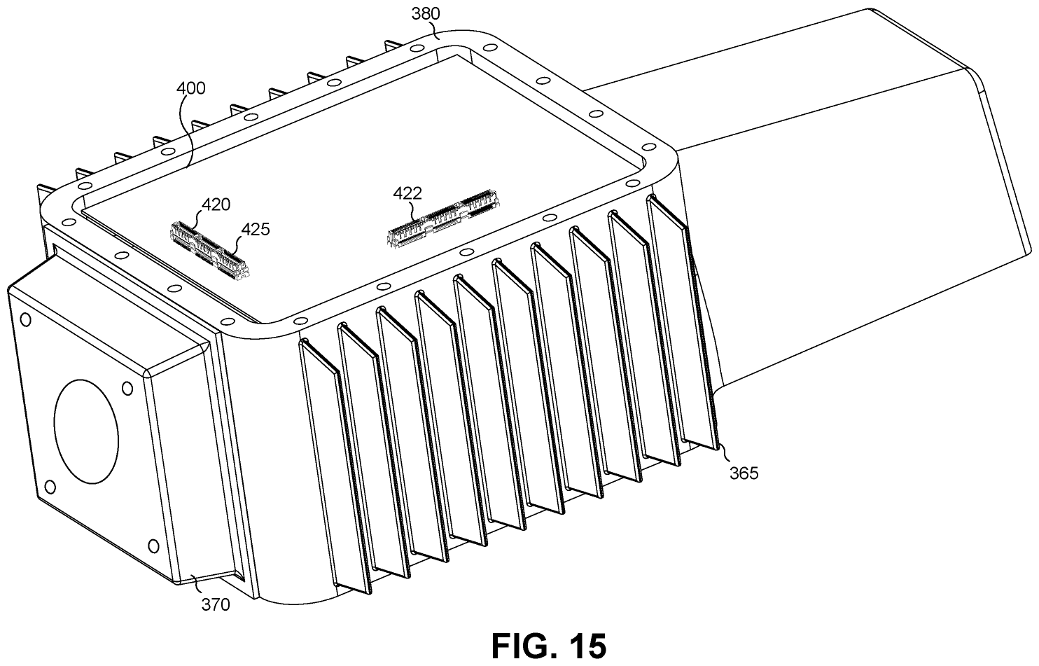

FIGS. 13A, 13B and 13C are pictorial representations that depict the structure of the top stacking network connector included on the platform controller and the mechanism by which a module interfaces there with. It should be appreciated that the platform 300 is intended to support various electronic modules in a stacking manner. In order to enable modules to stack without requiring significant modification of a particular module, it is important that the interface between a particular module, e.g. 500, and the platform controller 400 does not vary from one module to the next. For example, the top stacker network connector 420 included in the platform controller 400 provides a plurality of network interfaces. As shown in the figure, these are identified as “router port 0”, “router port 1” and so forth. It should be appreciated that when a particular module 500 is mated with the platform controller 400, a particular module 500 uses a bottom side stacker connector 510 to connect to the first router port included in the top side stacker connector 420, which is included in the platform controller 400.

The particular module 500 makes a connection 503 to this first port. The module 500 is then responsible to shift the remaining network interface ports so that the second available network interface port on the topside stacker connector 420 is made available on a topside stacker connector 505 included in that module 500. Accordingly, the module 500 should shift the second available network interface to the first network interface connector position in the topside stacker module 505 included in the first PCB module 500 to be mated with the platform controller 400. It should be likewise appreciated that the module 500 also shifts the third available network interface from the platform controller 400 to the second network interface position in the topside stacker 505 included in the PCB module 500. As such, when a second module interfaces to the first PCB module 500, it will likewise connect to the second network interface by way of the first network interface position included in the topside stacker 505 included in the first PCB module 500. In this matter, each subsequent module to connect to a lower module will always use the first network interface position on a topside stacker connector 505.

FIG. 13C is a pictorial diagram that illustrates the routing of network interfaces when a particular module 515 does not require a network interface port. It should be appreciated that, in such a situation, a module 515 simply passes a network interface from its bottom side stacker connector to the same position in its topside stacker connector.

FIGS. 14A and 14B are pictorial diagrams that illustrate distribution of metered power ports to modules that are installed in the platform. Distribution of metered power ports is accomplished in a manner analogous to that of distributing the plurality of network interfaces included in the top network interfaces stacker 420. As such, the plurality of DC power ports developed by the platform controller 400 are presented to a top stacking connector 425.

When a particular PCB module 530 needs metered power, it makes a connection 533 to a first DC power port by way of a bottom stacker connector 540. The PCB module 530 connects 533 to the DC power port in the first position included in the topside stacker connector 425 included in the platform controller 400. The module 530 that receives power from the first power port is then required to shift the remaining power ports so that the second power port included in the second position of the topside stacker 425 is shifted to the first position of the topside power stacker connector 535 included in the PCB module 530. Remaining power ports are shifted in an analogous manner so that the next module that is interfaced to the top of the stack receives its own DC power port in the first position of the power port top stacker connector 535 included in the module below that particular module.

FIG. 15 is a pictorial diagram that shows the installation of the platform controller in the central portion of the platform. This figure illustrates that, according to one alternative example embodiment, the central portion of the platform 300 includes a plurality of heat dissipation fins 365 that emanate outward from the side of the central portion of the platform 300. The shape and orientation of these heat dissipation fins 365 can vary based on the application of a particular platform 300. According to one alternative example embodiment, the heat dissipation fins 365 protrude outward from the center portion of the platform 300 and are oriented such that airflow from top to bottom covers the surface of the heat dissipation pin 365.

It should also be appreciated that, according to one alternative example embodiment, the central portion of the platform 300 includes an interface surface 380, also referred to as a mounting flange. The interface surface 380, in this alternative example embodiment, spans a perimeter about the central portion of the platform 300. As shown in FIG. 10, a corresponding mounting flange 381 is disposed on the bottom of the platform 300. Mounted within this perimeter, according to this alternative example embodiment, is a platform controller 400. The platform controller 400 further includes at least one or more of a computer bus connector 422, a platform network interface connector 420 and a platform measured DC power connector 425. It should be appreciated that, according to various alternative example embodiments, the platform network interface connector 420 and the platform measured DC power connector 425 encompass a same physical connector. However, many embodiments will have two separate connectors.

It should also be appreciated that, even though the platform controller 400 includes one or more processors, this example embodiment of a platform controller 400 does not utilize the computer bus connector 422 for data communications with other modules that may be stacked onto the platform 300. Rather, in this example embodiment the platform controller 400 provides the computer bus connector 422 to facilitate orientation of one or more modules stacking upon the platform 300. According to yet another alternative example embodiment, as shown in FIG. 3, the platform controller 400 includes an additional processor 426, wherein said additional processor 426 includes a bus interface which is communicatively coupled 461 to the topside computer bus connector 427. In this matter, a processor on the platform controller 400 is able to communicate by way of the computer bus with a module stacked onto the platform 300.

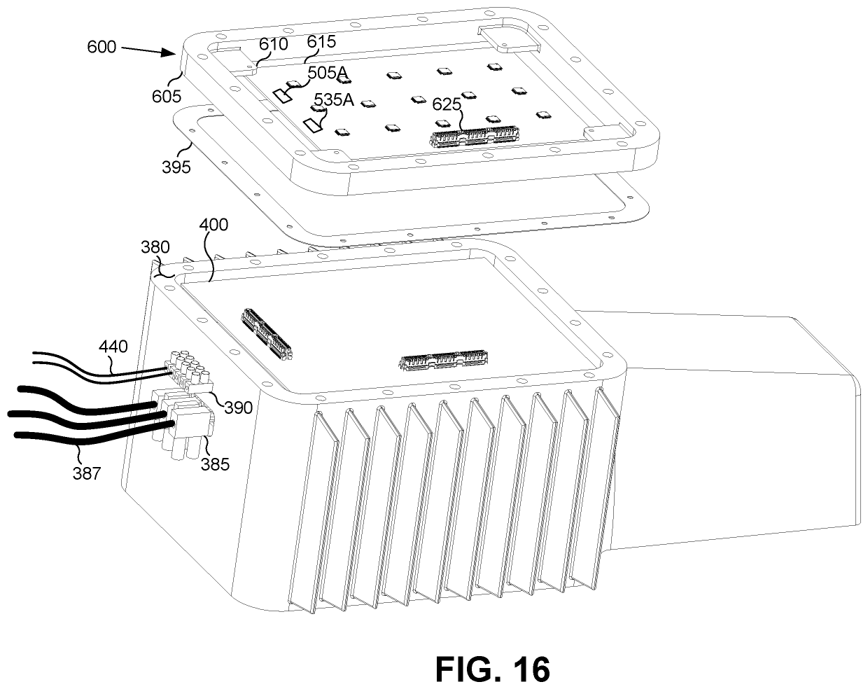

FIG. 16 is a pictorial diagram that illustrates the concept of an electronics slice. A slice is also referred to as an electronic element. It should be appreciated that, according to this alternative example embodiment, an electronics slice 600 comprises a mounting frame 605 and an electronic circuit assembly 615. The mounting frame 605 includes mounting tabs 610 which are used to mount the electronic circuit assembly 615. The electronic circuit assembly 615 includes, according to various alternative example embodiments, top and bottom stacker connectors for at least one or more of the platform network interface connectors, the platform DC measured power connectors, and the platform computer bus connectors 625.

When a slice 600 is mounted onto the platform 300, a gasket 395 is sandwiched between the interface surface 380 and a bottom surface of the slice 600. It should be appreciated that, according to various alternative example embodiments, the gasket 395 comprises a material that is thermally conductive and provides a moisture barrier when it is sandwiched between the interface surface 380 and the bottom surface of the sliced 600. It should be appreciated that, when an additional slice is mounted on top of the first slice 600, a second gasket is disposed between the first slice 600 and an additional slice that is mounted on top of the first slice.

FIG. 16 also illustrates that, emanating from a front portion of the central portion of the platform, are power lines 387 that are used to feed a streetlight fixture. In this embodiment, there is an output power connector 385 which receives power from a power transition module 322 by way of bus bars 330, 335 and 340. It should be appreciated that the opera power connector 385 is also hermetically sealed in a manner as described above.

FIG. 16 also illustrates that, according to yet another alternative example embodiment, an additional hermetically sealed connector 390 is used to convey dimming signals 392 to a streetlight. It should likewise be appreciated that these dimming signals 440 are received from the dimming controller 435 included in the platform controller 400.

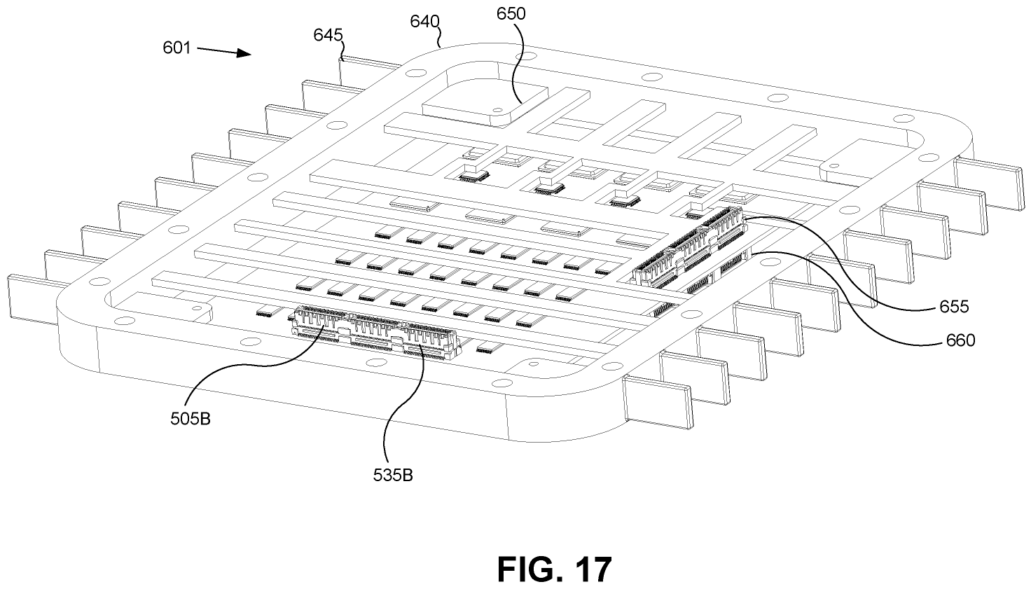

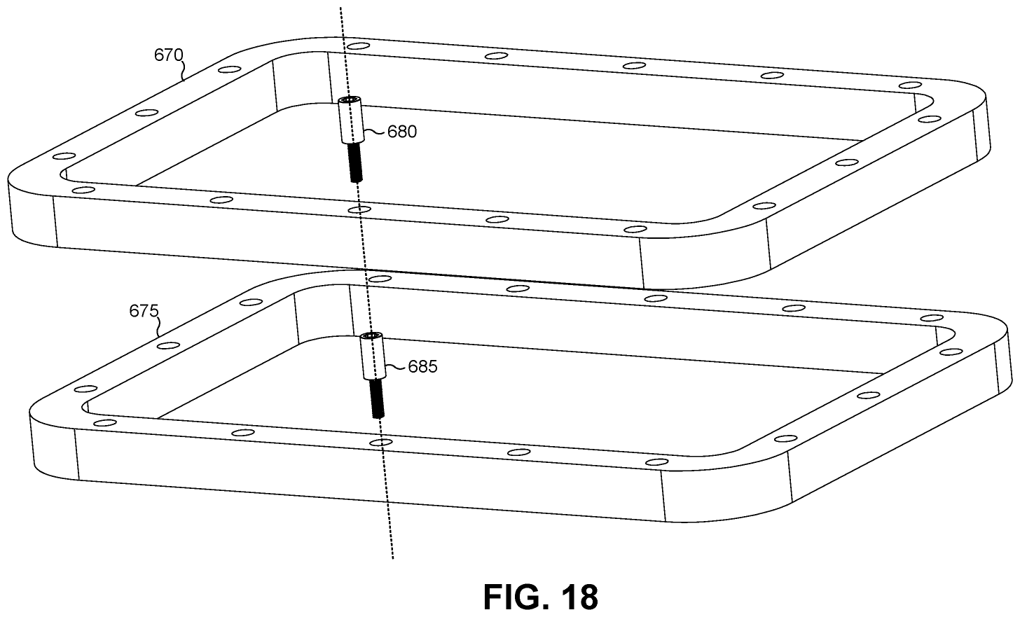

FIG. 17 is a pictorial diagram that illustrates one embodiment of a high-power slice. It should be appreciated that, according to one alternative example embodiment, a slice 601 includes heat dissipation fins 645 emanating outward from an external surface of the slice. It should be appreciated that, according to this alternative example embodiment, a sliced scissor one includes a frame 640 and mounting tabs 654 mounting a circuit board assembly onto the frame 640. As illustrated, the frame 640 of a high-power sliced 601, according to one alternative example embodiment, further comprises heat transfer webbing, which is used to provide a physical path for heat generated by electronic components so as to enable the heat to reach the outer perimeter of the frame.

FIG. 18 is a pictorial diagram that illustrates the use of concentric mounting fasteners for installing one slice upon another. In order to ensure that slices can be stacked one upon the other in a fixed orientation, one example embodiment provides for the use of a concentric male/female fastener (680, 685). When a first slice is mounted upon the platform 300, a concentric male/female fastener is used to secure the frame 675 of a first slice to the platform 300. When a second slice is mounted upon the first slice, a second concentric male/female fastener 680 is used to secure the frame 670 of the second slice to the first frame 675. In actuality, the male portion of the second concentric faster 680 engages with a female portion of the first fastener 685.

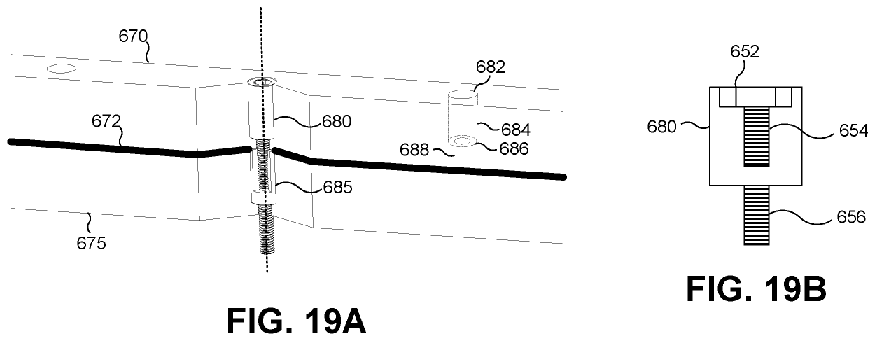

FIGS. 19A and 19B are pictorial illustrations that further clarify one alternative example embodiment of a concentric faster. It should be appreciated that, when the frame of a second sliced 670 is mounted to the frame of a second sliced 675, the gasketing material 672 is disposed between a top surface of the frame of the first slice 675 and the bottom surface of the frame of the second sliced 670.

A mounting hole 682 is included in the frame of a slice. According to this example embodiment, the mounting hole 682 has a first diameter 684 that is maintained downward through the frame 670 four approximately two thirds of the thickness of the frame 670. It should be appreciated that, the depth of the mounting hole 682 at the first diameter 684 is only described by example, and is not intended to limit the claims appended hereto. The first diameter 684 terminates in a caller 686 and then a smaller diameter 688 is presented from the caller six and 86 through the remainder of the slice.

The concentric fastener 680 includes a female threaded portion 654 and a male threaded portion 656. It should be appreciated that, at the top surface of the concentric faster 680 there is a torqueing feature 652. In one alternative example embodiment, the torqueing feature 652 comprises a hexagonal shape intended to receive a hexagonal driver, for example a driver commonly referred to as a “hex wrench”. The torqueing feature 652 projects downward from the top surface of the concentric fastener 680 to an extent that is necessary according to the type of material and the amount of torque necessary to fix the concentric faster to at least one or more of a threaded feature included in the mounting surface 380 and/or a second concentric faster 685, as shown in FIG. 8.

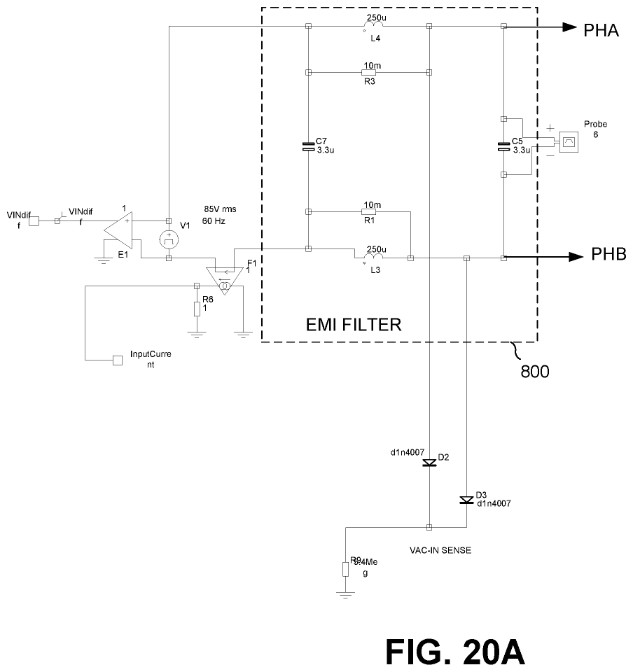

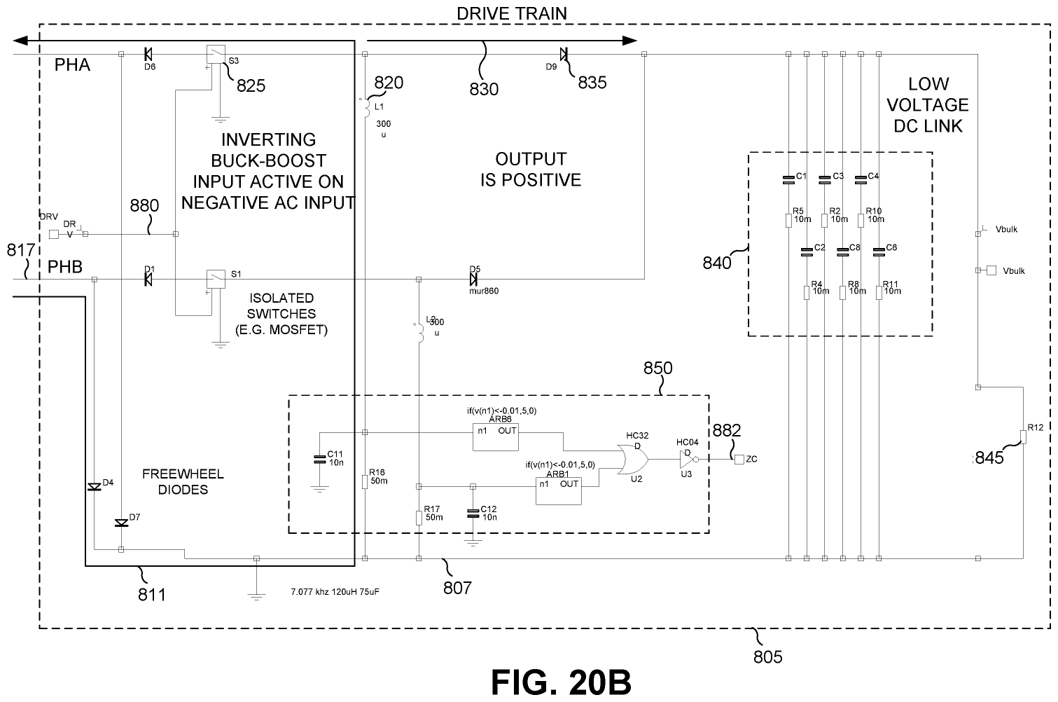

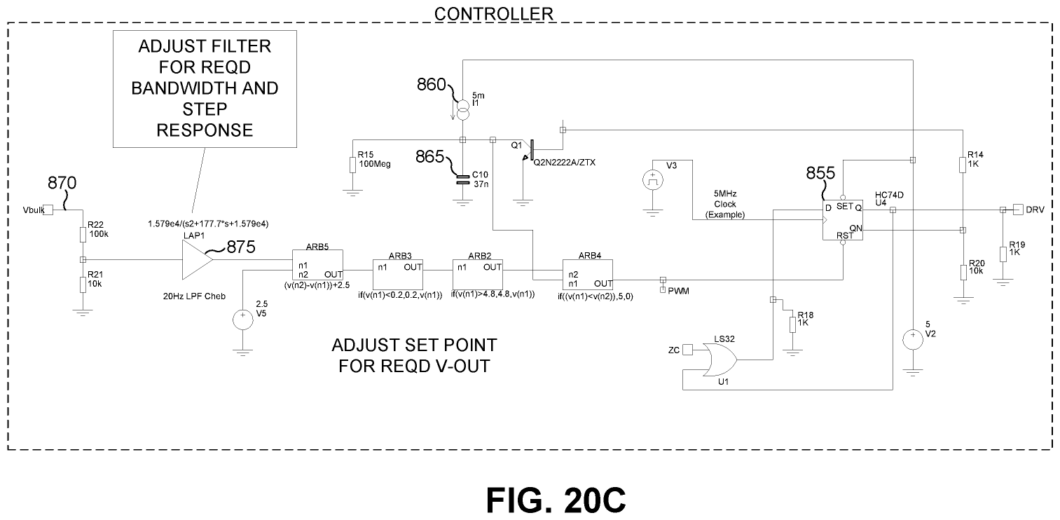

FIGS. 20A-20C are top level electrical schematics of one example embodiment of a low-voltage DC link power supply. It should be appreciated that most utility companies require that streetlight fixtures maintain a very high power factor as they present to the power grid used to provide electrical power to the platform 300. In the prior art, effective power factor correction could only be achieved where the DC link voltage is set at a very high value, for example 400 VDC or more. The reason for providing a very high DC link voltage in the prior art was to enable power factor correction over what is known as a universal AC input voltage, e.g. 85 VAC through 264 VAC. The DC link voltage must therefore be at a value greater than the peak of a 264 VAC sinewave. The requirement to operate over a universal AC input voltage drives the requirement that the DC link voltage be set at 400 VDC or more. In a significant achievement over the prior art, the DC link voltage in the claimed apparatus is set at a voltage lower than the peak VAC input.

FIG. 20A depicts that, according to one alternative example embodiment, the power supply 385 included in the platform 300 the power supply 325 comprises an electromagnetic interference filter 800. Techniques for designing an electromagnetic interference filter (EMI) are well-known and will not be described here. The output of the EMI filter realizes two power phases (PHA, PHB). It should be appreciated that, according to various illustrative use cases, one of these phases may in fact be a neutral or return line. In such case, only one phase is active. In other illustrative use cases, both phases present AC voltage, for example wherein one phase is typically 180° out of phase with the other phase.

FIG. 20B shows that, according to this alternative example embodiment, the power supply 385 includes a power train 805. The power train 805 is embodied as a bridgeless structure that drives an inverting buck-boost converter. It should be appreciated that, input diodes D6 and D1, are oriented so that current flows into the source of AC power when a power phase is at a lower potential than a ground reference 807. In this configuration, switches S3 and S1 enable a buildup of current in inductors L1 and L2. It should be appreciated that only one of these legs is active at any given time. So, when the input voltage on a first phase is negative compared to the second phase, current flows from the second phase through an inductor and is switched through the diode to the other phase.

In this presented illustrative embodiment, current path 811 illustrates current flow from Phase B (817) when the voltage potential of phase B is greater than the ground reference 807. Current flows through a clamping diode D4 from Phase B (817) and up through an inductor L1 (820). The current is pulsed with modulated by means of a switch S3 (825). When the switch S3 (825) is opened, current from the inductor 820 continues down an alternate path 830 through diode D9 (835). This current then feeds an energy storage bank 840, which in this alternative example embodiment comprises a bank of capacitors. Energy from the capacitor bank 840 drives a load, simulated by a resistor R12 (845).

Hence, the inverting buck-boost converter generates a voltage that is much lower, for example 75 V DC. This example included is not intended to limit the scope of the claims appended hereto. Because of the structure of the buck-boost converter, controlled by a drive signal “DRV” 880 is monotonic even though the peak voltage present on either phase may be lesser or greater than the DC link voltage. The drive train also includes current sensors. In this alternative example embodiment, the current sensors are low value resistors are 16 and are 17. However, current transformers are used in yet another alternative example embodiment, digital logic U2 and U3 combines the outputs of the two current sensors in order to generate a zero cross signal (“ZC”) 882.

FIG. 20C shows one alternative example embodiment of a pulse with modulated controller that achieves power factor correction at a low DC link voltage. Accordingly, a pulse width modulated signal is initiated only when the current flowing through both inductors is substantially zero, which is determined by zero crossing detectors depicted in FIG. 20B (850). The pulse width modulated (PWM) signal is generated according to a feedback signal 870 from the DC link voltage (Vbulk). The feedback is adjusted in bandwidth and step response according to well-known techniques and will not be discussed further here.

The output of the filter 875 is then directed to a set point comparator and a pulse width generator (collectively embodied as ARB3, ARB2 and ARB4). A flip-flop U4, is only set when the zero cross signal indicates there is substantially no current flowing through the two inductors. A constant current source I1 (860) is used in conjunction with a capacitor c10 (865) in order to establish a maximum pulse with for the on time. Feedback 875 from the voltage created on the capacitor bank 840 is scaled and filtered 875 and compared with a sawtooth wave generated by the constant current source 860 and capacitor 865. As In this manner, a classic borderline control concept for power factor correction is implemented, which requires no sensing of input voltage. It should also be appreciated that various control techniques for power factor correction are contemplated in the use of a borderline control concept is not intended to limit the scope of the claims appended hereto. It should likewise be appreciated that, according to various alternative example embodiments additional control features are included for shutting down the switches in the event of overcurrent condition.

Various alternative example embodiments provide a secondary voltage regulator that is driven by the DC link voltage. Accordingly, such secondary voltage regulators provide voltage to the platform controller 400. In some alternative example embodiments, the secondary voltage regulator is included in the platform controller 400. It should be noted that FIGS. 20A-20C present various values of electronic components which were selected based on simulation. Accordingly, any component values or other functional aspects of the controller shown in FIG. 20C are not intended to limit the scope of the claims appended hereto.

Aspects of the method and apparatus described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as electrically erasable programmable read-only memory i.e “EEPROM”), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for providing communication and processing for infrastructure comprising:
deploying an electronics bay by attaching the electronics bay to a streetlight support pole;
receiving electrical power from the streetlight support pole;
converting a portion of the electrical power into direct-current power for electronics; and
directing the remaining portion of electrical power to a streetlight support member attached to the electronics bay.

2. The method of claim 1 further comprising
receiving either into or onto the electronics bay at least one or more of a processing element, a sensor element, an image sensing element, an image recognition element, an image target tracking element, a communications element, a digital media streaming element, a wifi access point element, an Internet of things connection cell element, a streetlight dimming power controller and/or a streetlight power controller.

3. The method of claim 1 further comprising:
providing an internal communication channel that support communications amongst one or more of the a processing element, a sensor element, an image sensing element, an image recognition element, an image target tracking element, a communications element, a digital media streaming element, a wifi access point element, an Internet of things connection sell element, a streetlight dimming power controller and/or a streetlight power controller.

4. The method of claim 1 further comprising:
establishing a connection with a wide area network;
forming an internal local area network that includes a plurality of local network ports;
making one or more of the local network ports available on a stackable connector; and
establishing a routed connection from each of said local network ports to the established wide area network connection.

5. The method of claim 1 further comprising:
establishing a connection with a wide area network;
forming an internal local area network that includes at least one local area network port;
establishing a wireless network access point;
forming a routed channel from a device associating itself with the wireless network access point;
connecting the routed channel to the local network port; and
establishing a routed connection from the local network port to the established wide area network connection.

6. The method of claim 1 further comprising:
receiving direct current power from a power converter;
directing the direct current power to a plurality of power ports included in a stackable connector;
measuring the amount of direct current power flowing to one or more of the plurality of power ports;
maintaining a usage counter according to the measured direct current power provided to a particular power port; and
directing value from one or more of the usage counters to a metering authority.

7. The method of claim 1 further comprising:
receiving direct current power from a power converter;
directing the direct current power to a plurality of power ports included in a connector;
measuring the amount of direct current power flowing to one or more of the plurality of power ports;
maintaining a usage counter according to the measured direct current power provided to a particular power port; and
directing value from one or more of the usage counters to a metering authority.

8. The method of claim 1 wherein converting a portion of the electrical power into direct-current power for electronics comprises:
associating a first inductor with a first power phase, said first inductor having one end tied to a ground point;
associating a second inductor with a second power phase, said second inductor having one end tied to the ground point;
storing energy in the first inductor when the first power phase is at a potential less than that of the second power phase;
storing energy in the second inductor when the second power phase is at a potential less than that of the first power phase;
clamping the first power phase to a ground point when the first power phase is at a potential greater than that of the second power phase;
clamping the second power phase to the ground point when the second power phase is at a potential greater than that of the second power phase;
releasing the energy stored in at least one or more of the first inductor and/or the second inductor into an energy storage device tied to the ground point; and
providing energy from the energy storage device to a load referenced to the ground point.

9. The method of claim 1 wherein storing energy in the first and second inductors comprises:
modulating the duty cycle of energy storage such that the release of energy from either the first or second inductor is accomplished at a positive voltage level that is less than half of a peak-to-peak voltage between the first and second power phases and the current flow in either the first or second inductor is substantially synchronous with the voltage waveform of the peak-to-peak voltage between the first and second power phases.

10. A light pole electronics platform comprising:
streetlight pole mounting mechanism;
electronics bay shrouded by an included bulkhead;
rear electrical contact for connecting to electrical wires emanating from a streetlight pole, said rear electrical contact protruding through the bulkhead;
power supply disposed in the electronics bay; and
power breakout unit that distributes power received through the rear electrical contact to the power supply.

11. The light pole electronics platform of claim 10 wherein the rear electrical contact comprises:
flow-through barrier strip that includes a forward facing contact and a rear facing contact that are electrically common;
barrier strip inserted into the forward facing contact and which protrudes through the bulkhead of the electronics bay; and
sealant that forms a seal between the bulkhead and the barrier strip.

12. The light pole electronics platform of claim 10 further comprising:
platform controller disposed in the electronics bay that comprises:
network interface for connecting to a wireless data network;
platform router that is connected to the network interface and provides a plurality of local network ports; and
stackable connector for electrically coupling a quantity of the local area network ports to an electronic element.

13. The light pole electronics platform of claim 12 wherein the platform controller further comprises:
direct-current power input port for receiving direct-current power from the power supply;
computer bus power interface for providing direct-current power to a computer bus structure;
direct-current power metering subsystem that includes a plurality of power ports and a plurality of power meter counters for recording the amount of power consumed by each of power port
processor communicatively coupled to local area network port and also communicatively coupled to the direct-current power metering subsystem, said processor being programmed to retrieve a value from a power meter counter and convey said value to the local area network port.

14. The light pole electronics platform of claim 13 wherein the computer bus structure comprises at least one or more of a STD Bus, STD 32 bus, VME Bus, VME64 Bus, PCI bus, PCIe bus, PCI/104 bus, and/or PCIe/104 bus.

15. The light pole electronics platform of claim 13 wherein the platform controller further comprises:
dimming controller for creating dimming signals for a streetlight, said dimming signals connected to a front electrical contact that protrudes through the bulkhead of the electronics bay;
processor communicatively coupled to local area network port and also communicatively coupled to the dimming controller, said processor being programmed to receive a dimming value from the local area network port and direct the dimming value to the dimming controller.

16. The light pole electronics platform of claim 10 wherein the power supply comprises:
first inductor tied at one end to a ground point and at the other end to a switching point;
switch for enabling current from the ground point through the inductor to a first power phase;
diode in series with the switch to enable current flow when the first power phase is at a potential less than the ground point;
clamping diode from a second power phase to the ground point for passing current from the second power phase to the ground point when the second power phase is at a potential greater than that of the ground point;
diode attached at its anode to the switching point and to a storage device at its cathode; and
controller to cause the voltage at the storage device to be regulated to a level less than half the peak-to-peak voltage between the first and second power phases and to force the current flowing through the inductor to be in sync with the peak-to-peak voltage between the first and second power phases.

17. The light pole electronics platform of claim 10 further comprising:
mounting pipe attached to an outer front-facing plane included in the electronics platform;
front electrical contact that receives electrical power from the power breakout unit and protrudes through the bulkhead;
and
electrical conductors electrically coupled to front electrical contact, said electrical conductors drawn thorough the mounting pipe.

18. The light pole electronics platform of claim 10 further comprising at least one or more of an upper mounting flange and/or a lower mounting flange.

19. The light pole electronics platform of claim 18 further comprising:
an optical sensor housing that is mounted to either the lower or the upper mounting flange.

20. The light pole electronics platform of claim 18 further comprising:
electronic element that is mounted to either the lower or the upper mounting flange.

21. The light pole electronics platform of claim 18 further comprising:
first electronic element that is mounted to either the lower or upper mounting flange; and
second electronic element that is mounted to the first electronic element and wherein the first electronic element includes a stackable connector for interfacing a computer bus structure to the second electronic element.

22. The light pole electronics platform of claim 18 further comprising:
first electronic element that is mounted to either the lower or upper mounting flange; and
second electronic element that is mounted to the first electronic element and wherein the first electronic element includes a stackable connector for providing metered power to the second electronic element.

23. The light pole electronics platform of claim 18 further comprising:
first electronic element that is mounted to either the lower or upper mounting flange; and
second electronic element that is mounted to the first electronic element and wherein the second electronic element is secured to the first electronic element using a concentric fastener.
